(19) United States
(12) Patent Application Publication
(10) Pub. No.: US 2021/0393462 A1
(43) Pub. Date: Dec. 23, 2021

(54) BALL COMBINATION MODULE WITH PRESSURE DETECTION AND REGULATION

(71) Applicant: Gold Nanotech, Inc., Taipei City (TW)

(72) Inventor: Mei-Hua Chou, Taipei City (TW)

(21) Appl. No.: 16/904,414

(22) Filed: Jun. 17, 2020

(51) Int. Cl. A61G 7/057; A47C 27/10

(52) U.S. Cl. CPC A61G 7/05776; A47C 27/083; A61G 2203/34; A47C 27/10

(57) ABSTRACT

A ball combination module capable of detecting and regulating a posture pressure has the requirement of regulating individual independent ball pressures and lifting and lowering functions and mainly includes one or multiple sets of pressure controlling ball modules. Each pressure controlling ball module is connected to a cylinder connected to an external pressure source and is configured with an independent inflating/deflating electromagnetic valve set including a pressure-sensing intake control electromagnetic valve of controlling inflation, a deflation control electromagnetic valve of regulating deflation and a pressure sensor. The external pressure source has a pressure regulator providing a stable pressure gas source. A main gas supply conduit connected to multiple shunts provides inflation and deflation for all the pressure controlling ball modules. The pressure controlling ball modules are combined to constitute a large-area support region and achieve the dot-like pressure regulating and lifting and lowering functions for the comprehensive single ball.

### BACKGROUND OF THE INVENTION

### (1) Field of the Invention

The invention relates to a pressure controlling ball module design capable of individually regulating a pressure, and more particularly to a pressure controlling ball module design. When the pressure controlling ball module design constitutes a large-area seat cushion and mattress, it provides the sitting and lying support mode best fit with the human body, in a dot-like pressure detection and regulation manner to achieve the effects of detecting the posture pressure and distribution parameter at any time, and precisely and timely solving the blood circulating problem caused by the pressure concentration and long-term sitting and lying.

### (2) Description of the Prior Art

The pressure ulcer is a big problem for the handicapped and long-term bedridden person in the nursing care. The main reason of causing the pressure ulcer is that the affected part is compressed for the too long time, and the frequent locations are often absolutely associated with the areas, where human bones protrude, such as the heel, buttock or coccyx frequently contacting with the mattress and the seat.

Most of the frequently seen market available air inflation mattresses are present in an overall bed, or divided into several blocks in a block-like or stripe-like design to perform pressure-dividing so that the block can be inflated or deflated in a timing or partitioning manner. However, such configuration still cannot comprehensively solve the formation of the pressure ulcer, and also cannot avoid the formed wound or the pressure ulcer block to be formed. At present, although some manufacturers have developed the so-called smart sensitive mattresses, the dot-like precise regulation still cannot be achieved because the block design of the inflatable bed only can control the inflation and deflation in the specific blocks.

Thus, it is a positive task for the present invention to provide a dynamic posture pressure regulating support, which can provide effective posture analysis and the fixed-point regulation with precise and appropriate pressure to make the long-term bedridden patient or the wheelchair patient have the more precise and conformable feeling.

### SUMMARY OF THE INVENTION

A main objective of the invention is to provide a ball combination module with pressure detection and regulation, wherein multiple individually or comprehensively controlled ball pressing modules constitute a large-area inflatable support region to achieve the dynamic functions of comprehensive dot-like independent pressure detecting and regulating, lifting and lowering, and pressure supporting so that the pressure ulcers can be eased and the loading on the health care worker or family member can be decreased.

Another objective of the invention is to provide a ball combination module with pressure detection and regulation, which can be combined with the computer software design to provide digits and/or images for presentation, and it is possible to regulate more function modes, such as the human body positioning, posture analyzing, affected portion circling, intelligent trace positioning and various combinations of dynamic soft/hard modes. Thus, the ball combination module can be applied to the wheelchair cushion or the mattress combination and the combination area is also not restricted.

To achieve the above-mentioned objectives, the invention provides a new and convenient ball combination module with pressure detection and regulation and lifting and lowering functions. The ball combination module includes: one or multiple sets of pressure controlling ball modules composed of pressure controlling balls, and a combination board having a surface configured with fixing holes into which the pressure controlling balls are embedded; each pressure controlling ball is configured with a cylinder connected to an external pressure source and is provided with an independent inflating/deflating electromagnetic valve set including a pressure-sensing intake control electromagnetic valve for inflation, a deflation control electromagnetic valve for deflation and a pressure sensor; the external pressure source has a pressure regulator providing a stable pressure gas source. A main gas supply conduit connected to multiple shunts provides inflation sources for all the pressure controlled balls.

As mentioned hereinabove, using pressure controlling balls with pressure controlling and lifting and lowering functions to constitute an inflation ball support region with an arbitrary area size can achieve the comprehensive dot-like pressure regulation and lifting and lowering and dynamic regulation functions best fit with human engineering. When being used as a wheelchair cushion or mattress, the pressure sensors for the pressure controlled balls can feed back posture pressure signals analyzed by a program to achieve the effect of controlling individual pressure controlled balls to regulate the support pressure and provide the lifting and lowering functions, so that the long-term wheelchair-depending and bedridden patients can avoid the wound compression and have the decreased pressure ulcers.

The combination board is directly formed by a plate having a required area size, or by bridging multiple plates having inverse-U shaped cross-sections.

A ball of the pressure controlling ball has one single opening to be combined with the cylinder, and the pressure controlling ball can pass through the fixing hole on the surface of the combination board to form lifting and lowering functions.

Each of the independent inflating and deflating electromagnetic valve sets has a gas conduit communicated with the pressure-sensing intake control electromagnetic valve and the deflation control electromagnetic valve. The pressure-sensing intake control electromagnetic valve is connected to the external pressure source to provide inflation conduit control. The deflation control electromagnetic valve is connected to the gas conduit to provide a deflation conduit. Also, the inflating/deflating electromagnetic valve is further provided with electromagnetic valve control lines, and the pressure-sensing intake control electromagnetic valve is further provided with a pressure sensor.

The pressure controlled ball module further includes a circuit control system independently present or integrated with an external computer apparatus. The circuit control system has: an electromagnetic valve controller electrically connected to all the electromagnetic valve control lines; and a signal analyzing processor electrically connected to all the pressure sensors.

The fixing board and the pressure controlling ball modules may extend longitudinally or transversally to form an anti-pressure-ulcer board pad having an arbitrary area size.

The anti-pressure-ulcer board pad may be applied to a mattress or a wheelchair cushion.

### BRIEF DESCRIPTION OF THE DRAWINGS

FIG. 1 is an overall appearance view showing an anti-pressure-ulcer board pad of the invention.

FIG. 2 is an overall side view showing the anti-pressure-ulcer board pad of the invention.

FIG. 3 is a decomposed schematic view showing a pressure controlled ball of the invention.

FIG. 4 is an assembled schematic view showing a pressure controlling ball module of the invention.

FIG. 5 is a schematic arrangement view showing the ball, the electromagnetic valve cylinder and the external pressure source of the invention.

FIG. 6 is a schematic arrangement view showing the ball, the electromagnetic valve and the circuit control system of the invention.

FIG. 7 is a schematic arrangement view showing a system function of the anti-pressure-ulcer board pad of the invention.

### DETAILED DESCRIPTION OF THE PREFERRED EMBODIMENTS

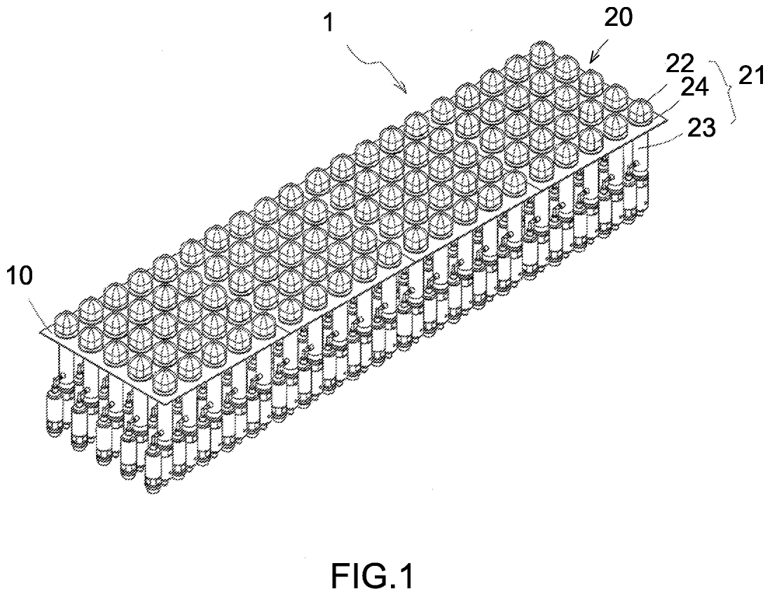

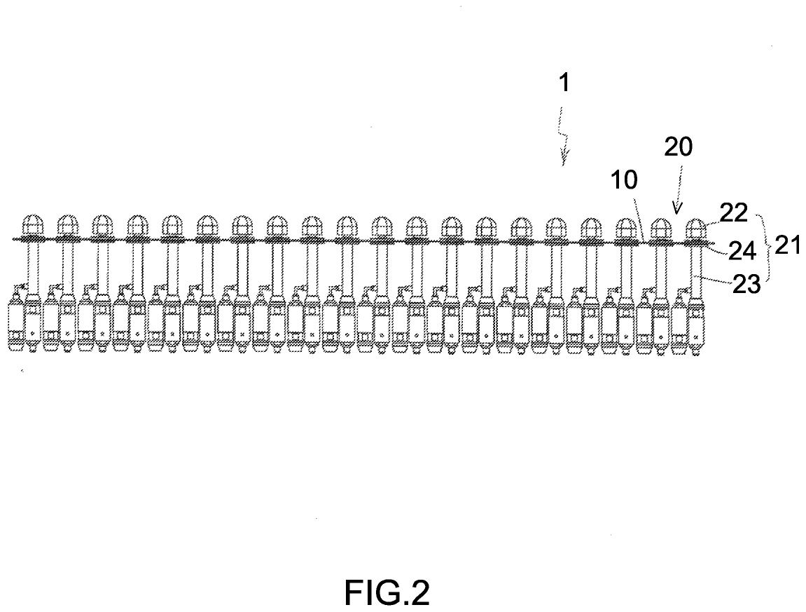

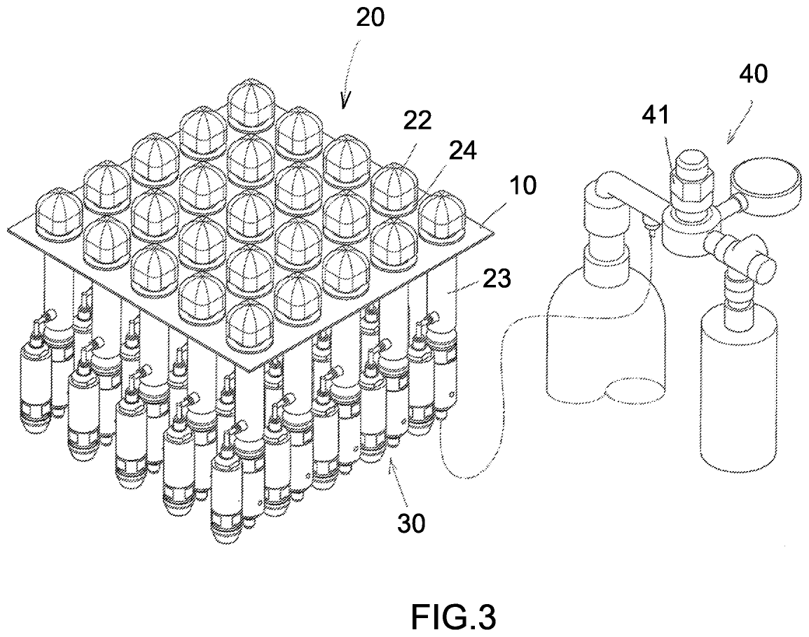

Referring concurrently to FIGS. 1 and 2, the invention discloses a ball combination module with pressure detection and regulation. The ball combination module mainly includes one or multiple sets of pressure controlling ball modules 20 extending longitudinally or transversally to constitute a large-area pattern. Referring to FIG. 3, the pressure controlling ball module 20 includes: multiple pressure controlling balls 21 each being composed of a ball 22, a cylinder 23 and gaskets 24; multiple inflating/deflating electromagnetic valve sets 30 respectively corresponding to the multiple pressure controlling balls 21 in a one-to-one manner. Each inflating/deflating electromagnetic valve set 30 is configured with a gas conduit 31, a pressure-sensing intake control electromagnetic valve 32, a deflation control electromagnetic valve 33 and a pressure sensor 34. The multiple pressure controlling balls 21 are connected to fixing holes 11, formed on a surface of a combination board 10, and the gaskets 24 to constitute a complete pressure controlling ball module 20 together with the corresponding inflating/deflating electromagnetic valves 30. Thus, when an anti-pressure-ulcer board pad 1 with an arbitrarily required area size is formed, it is only necessary to longitudinally or transversally extend the combination board 10 to have the desired area.

Upon implementation, the combination board 10 can be directly formed by a plate having a required area size, or by bridging multiple small plates having inverse-U shaped cross-sections into an integrally large-area type and forming equally spaced fixing holes 11 on the surface of the combination board 10, so that it can be combined with the ball 22 and the cylinder 23 simply and conveniently.

Referring to FIG. 2, the combination board 10 is a large-area sheet, and the gaskets 24 are disposed above and below each fixing hole 11 to clamp and fix the combination board 10, so that the fast combination can be achieved, and the detachment can be avoided.

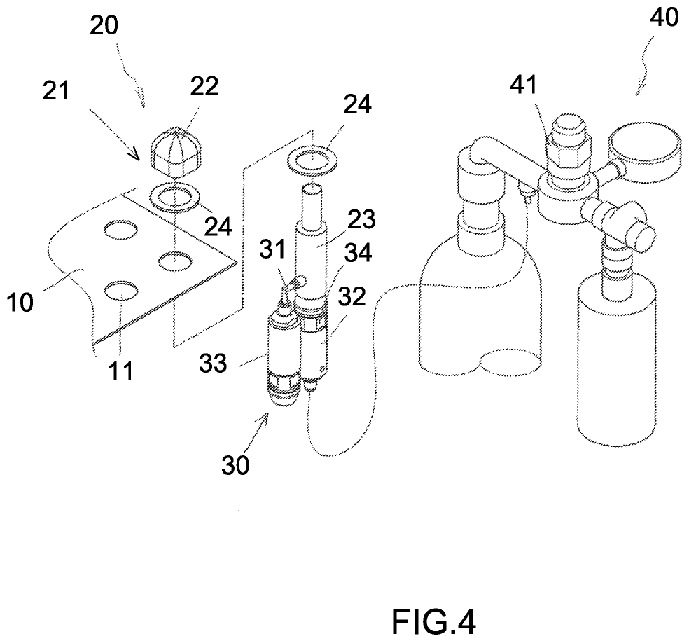

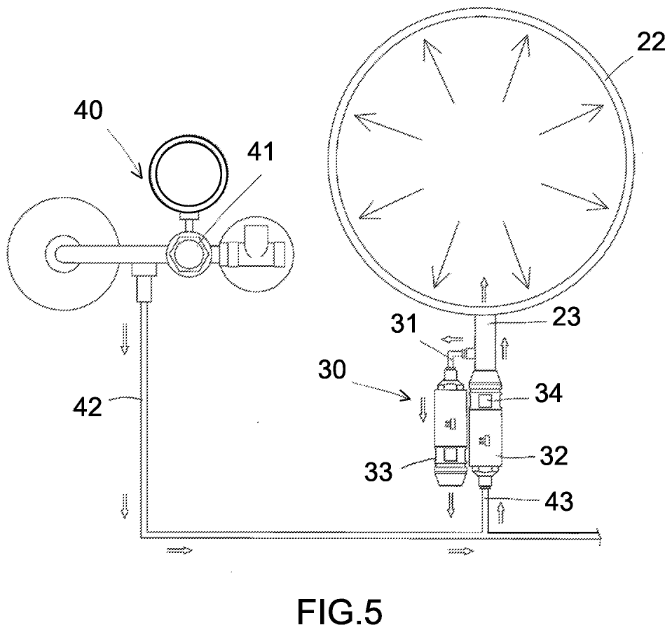

Referring also to FIGS. 3 to 5, the pressure controlled ball module 20 is a modularized combination structure including multiple pressure controlled balls 21 arranged regularly. The specific structure of each pressure controlled ball 21 includes a ball 22, a cylinder 23 and gaskets 24. The ball 22 has one single opening to be combined with the cylinder 23. The cylinder 23 provides the inflating/deflating conduit for the ball 22, and also makes the ball 22 projectingly extend out of the fixing hole 11 of the combination board 10 to form the lifting and lowering effects. Also, the upper and lower gaskets 24 fix and position the cylinder 23 to prevent the detachment. Furthermore, each cylinder 23 is connected to an inflating/deflating electromagnetic valve set 30.

The inflating/deflating electromagnetic valve set 30 includes a gas conduit 31 connected to a deflation control electromagnetic valve 33 and a pressure-sensing intake control electromagnetic valve 32. The pressure-sensing intake control electromagnetic valve 32 has one end connected to the cylinder 23, and the other end that can be connected to an external pressure source 40 providing the inflation conduit and control. A free end of the deflation control electromagnetic valve 33 provides the deflation conduit. The inflating/deflating electromagnetic valve set 30 is further provided with electromagnetic valve control lines 321 and 331, and the pressure-sensing intake control electromagnetic valve 32 is provided with a pressure sensor 34 at an air inlet connected to the ball 22. The pressure sensor 34 has a sensor transmission cable 341 to be connected to the external computer apparatus, so that the detected pressure of each pressure controlling ball module 20 obtained by the pressure sensor 34 is inputted to the computer apparatus for determining the bearing pressure and time, and further regulating the support mode with the softness formed by the lifting and lowering of the cylinder 23 and the regulated pressure of the pressure controlling ball 21.

The external pressure source 40 is a large gas supply source, which may be actually, for example, a high pressure steel bottle containing a high-pressure gas, an air compressor or the like. Also, the external pressure source 40 has a pressure regulator 41, a main gas supply conduit 42 and multiple shunts 43 connected together to provide gas pressure sources for all the pressure-sensing intake control electromagnetic valves 32, respectively. The pressure regulator 41 can regulate the maximum pressure to be used, and provide the inflating source to the pressure-sensing intake control electromagnetic valve 32 of each pressure controlled ball module 20 through the main gas supply conduit 42 and all shunts 43.

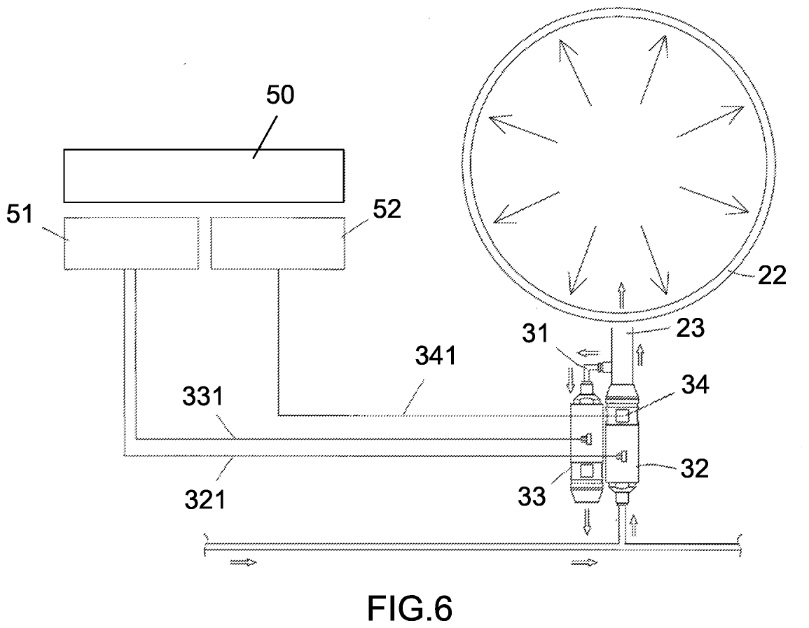

Referring again to FIG. 6, the pressure controlled ball module 20 further includes a circuit control system 50, which is independently present or integrated with the external computer apparatus. The circuit control system 50 further has an electromagnetic valve controller 51 and a signal analyzing processor 52. The electromagnetic valve controller 51 is electrically connected to all the electromagnetic valve control lines 321 and 331 of the pressure-sensing intake control electromagnetic valve 32 and the deflation control electromagnetic valve 33. The signal analyzing processor 52 is electrically connected to all the pressure sensors 34 of all the pressure-sensing intake control electromagnetic valves 32. Thus, the circuit control system 50 can control and set different pressure values at the independent balls 22 and detect the feedback messages through the sensor transmission cable 341 of the pressure sensor 34, and can control the electromagnetic valve controller 51 to completely control the pressure regulation for the inflation and deflation for all the pressure-sensing intake control electromagnetic valves 32, the deflation control electromagnetic valves 33 and the corresponding pressure controlled balls 21.

Upon implementation of forming the anti-pressure-ulcer board pad 1 by a fixing board 10 having the required size and the pressure controlling ball module 20, the pressure regulator 41 firstly regulates the highest pressure value upon use. Next, the high-pressure gas is provided to the inflation gas sources for all the pressure controlled balls 21 from the main gas supply conduit 42 through the shunts 43 and through the external pressure source 40.

At this time, the circuit control system 50 enables the electromagnetic valve controller 51 to open all the pressure-sensing intake control electromagnetic valves 32 and inflate the pressures in the balls 22 to the pressure values set by the pressure regulator 41. The pressure sensor 34 at the gas inlet portion on the pressure-sensing intake control electromagnetic valve 32 detects and feeds back the pressure signal to the circuit control system 50, which checks whether the pressure value is correct, and the pressure-sensing intake control electromagnetic valve 32 is closed when the set pressure value is reached. If the pressure in the ball 22 is higher than the set pressure value, then the deflation control electromagnetic valve 33 is enabled to deflate. Each pressure sensor 34 transfers the pressure signal to the signal analyzing processor 52 and the circuit control system 50, and the pressure parameters are calibrated. Then, the fast switch operation of the inflating/deflating electromagnetic valve set 30 is used to regulate the pressure of the gas source of each pressure controlling ball 21 entering the gas volumes of the ball 22 and the cylinder 23. Thus, it is possible to regulate the lifting and lowering effects of the cylinder 23 best fit with the support of the human body and the pressure regulation function of the softness of the ball 22.

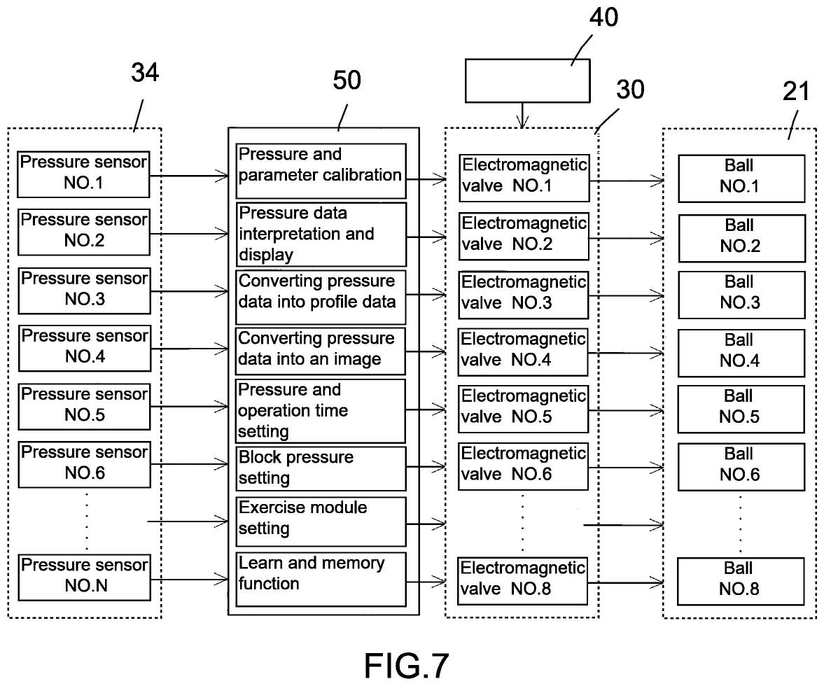

FIG. 7 is a schematic arrangement view showing a system function of the anti-pressure-ulcer board pad of the invention. Referring to FIG. 7, the functions relating to the circuit control system (or in conjunction with the computer apparatus) include: pressure and parameter calibration, pressure data interpretation and display, converting pressure data into profile data, converting pressure data into an image, pressure and operation time setting, block pressure setting, exercise module setting, learn and memory function or the like. Upon implementation, after the circuit control system has been combined with the computer apparatus, the corresponding software may further be used to provide the digits and/or images for presentation, and it is possible to regulate more function modes, such as the human body positioning, posture analyzing, affected portion circling, intelligent trace positioning, height adjusting and pressure increasing and decreasing for individual balls, and various combinations of dynamic soft/hard modes, thereby significantly enhancing the overall utility function.

According to the above-mentioned explanation, it is obtained that the invention adopts multiple independent pressure controlled balls having the independent height and pressure regulating functions, and the modularized design can freely construct the mattress structure by longitudinal or transversal combinations. It is possible to take one single set of pressure controlled ball modules to constitute a small-type board pad pattern to function as the wheelchair cushion according to the actual usage requirement, or to take multiple pressure controlled ball modules to constitute a board pad pattern with a large surface area to function as a mattress. Furthermore, the pressure controlled ball module has multiple independent electromagnetic valves provided with pressure sensors to independently detect the local single-point pressure values of the human body contacting the pressure controlled ball, wherein the detected pressure values are analyzed to individually control the balanced pressures in the pressure controlled ball and the soft/hard modes.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A ball combination module with pressure detection and regulation, comprising one or multiple sets of pressure controlling ball modules longitudinally or transversally extending to constitute a large-area pattern, the pressure controlling ball module further comprising:
multiple pressure controlling balls composed of balls and cylinders connected to the balls in a one-to-one manner;
a combination board having a surface formed with fixing holes to allow the cylinder and the ball to pass reciprocatingly in conjunction with upper and lower gaskets to perform clamping and positioning; and
an inflating/deflating electromagnetic valve set and a pressure sensor connected to the cylinder.

2. The ball combination module according to claim 1, wherein the combination board is directly formed by a plate having a required area size, or by bridging multiple plates having inverse-U shaped cross-sections.

3. The ball combination module according to claim 1, wherein the ball of the pressure controlling ball has one single opening connected to the cylinder, the cylinder is communicated and connected to the inflating/deflating electromagnetic valve set, and the pressure sensor has module sensing and regulating functions.

4. The ball combination module according to claim 1, wherein a pressure-sensing intake control electromagnetic valve of the inflating/deflating electromagnetic valve set is connected to the cylinder and an external pressure source to provide inflation control, and the deflation control electromagnetic valve is connected to the cylinder through the gas conduit to provide deflation control.

5. The ball combination module according to claim 4, wherein the inflating/deflating electromagnetic valve set further comprises electromagnetic valve control lines for electrical connections to the pressure-sensing intake control electromagnetic valve, the deflation control electromagnetic valve, and a circuit control system, wherein the circuit control system is independently present or integrated with an external computer apparatus and comprises: an electromagnetic valve controller electrically connected to the electromagnetic valve control lines of the pressure-sensing intake control electromagnetic valve and the deflation control electromagnetic valve; and a signal analyzing processor electrically connected to the pressure sensors of all the pressure-sensing intake control electromagnetic valves.

6. The ball combination module according to claim 1, wherein the sets of pressure controlling ball modules longitudinally or transversally extend to freely form an anti-pressure-ulcer board pad having an arbitrary area size.

7. The ball combination module according to claim 6, wherein the anti-pressure-ulcer board pad is applied to a mattress or a wheelchair cushion.
